(19) United States
(12) Patent Application Publication
(10) Pub. No.: US 2026/0094958 A1
(43) Pub. Date: Apr. 2, 2026

(54) Abrupt Transient Energy Surge Instaneous Cutoff

(71) Applicants: David E. BARRETT, Eau Claire, WI (US); Jon Joseph ZECHERLE, Humbird, WI (US)

(72) Inventors: David E. BARRETT, Eau Claire, WI (US); Jon Joseph ZECHERLE, Humbird, WI (US)

(21) Appl. No.: 18/826,567

(22) Filed: Sep. 6, 2024

Related U.S. Application Data
(60) Provisional application No. 63/536,859, filed on Sep. 6, 2023.

(51) Int. Cl. H01Q 1/00; H01Q 1/50

(52) U.S. Cl. CPC H01Q 1/002; H01Q 1/50

(57) ABSTRACT

An electronic device includes a microprocessor, a memory coupled to the microprocessor, and a communications port including an antenna. The communications port is in electrical communication with the microprocessor for sending and receiving signals. An amplifier amplifies signals received by the antenna. A first transorber and a second transorber referenced to one another monitor an amount of gain such that when a gain signal goes beyond a threshold value, the other of the first transorber and the second transorber, shorts the incoming signal to ground until the amount of gain is equal to or less than the threshold value.

### TECHNICAL FIELD

The subject matter disclosed herein relates to protective containers for electronic equipment, and in particular, to enclosure systems and methods for protecting telecommunications equipment from high-power electromagnetic signals.

### BACKGROUND

A nuclear detonation far above the earth's surface, for example at 25 miles above sea level, produces an electromagnetic field known as a high altitude electromagnetic pulse (HEMP). Such pulses or energy spikes can cause damage and failure to power systems, telephone networks, electronic devices, and computers across a large geographical area. Systems connected to power lines and telephone wires are particularly vulnerable to the current and voltage surges resulting from an electromagnetic pulse.

During a HEMP event, damage to telecommunications equipment can be prevented or ameliorated through the use of a protective metallic shielding. For example, telecommunications equipment may be stored in a room having HEMP protected walls. Current approaches for protecting telecommunications racks and enclosures from HEMP exposure are often costly, however, and not well suited for efficient use with standard sized telecommunications storage facilities and components. For example, in some cases custom protected rooms are built to store telecommunications racks. In other cases, vendors lease multiple telecommunications rooms or spaces in which to store oversized hardened enclosures.

Other systems include a number of control boxes which communicate via RF signals or the like. For example, railroads have control boxes positioned all along the rails. The control boxes include sensitive circuitry which controls the various switches, lights and other systems associated with the railroad system. The control boxes can be made of shielding material and many of the electrical components within the control boxes include surge protection. However, such a control box has a major weakness. An antenna is needed so that the control box can send and receive control signals and communicate with other control boxes or a central computer. The antenna opening is an open door for electrical energy to enter the control box and overwhelm the components within the control box.

### SUMMARY

According to one aspect, an antenna system includes an antenna configured to receive electromagnetic signals. One or more electrical components are in electrical communication with the antenna. An electromagnetic pulse (EMP) protection unit is electrically coupled with the antenna and the one or more electrical components. The EMP protection unit includes an amplifier, a first transober, and a second transober. The amplifier is disposed between the first transober and the second transober.

According to another aspect, an electronic device includes a microprocessor, a memory coupled to the microprocessor, and a communications port including an antenna. The communications port is in electrical communication with the microprocessor for sending and receiving signals. An amplifier amplifies signals received by the antenna. A first transorber and a second transorber referenced to one another monitor an amount of gain such that when a gain signal goes beyond a threshold value, the other of the first transorber and the second transorber, shorts the incoming signal to ground until the amount of gain is equal to or less than the threshold value.

### BRIEF DESCRIPTION OF THE DRAWINGS

FIG. 1A is a diagrammatic view of an unprotected antenna system, according to some embodiments.

FIG. 1B is a diagrammatic view of an unprotected antenna system on a main server, according to some embodiments.

FIG. 2A is a diagrammatic view of an antenna system including an EMP protection unit, according to some embodiments.

FIG. 2B is a diagrammatic view of an antenna system including an EMP protection unit exposed to a high-power EMP, according to some embodiments.

FIG. 3 is a schematic diagram of an antenna system including an EMP protection unit, according to some embodiments.

FIG. 4 is a diagrammatic view of a computing system for a machine, according to some embodiments.

FIG. 5 is a diagrammatic view of a machine readable medium including an instruction set, according to some embodiments.

### DETAILED DESCRIPTION

The present disclosure describes devices, systems, and methods for protecting electronic circuitry or communication systems from high-power electromagnetic pulse (EMP) events received upon an antenna. The EMP protection unit is configured to suppress transient voltages received on the antenna, e.g., from EMP events and/or lightning strikes. The EMP protection unit includes one or more transorbers, or transient voltage suppression (TVS) diodes to suppress surge voltages. In some embodiments, the EMP protection unit includes a first transorber positioned on an output side of an amplifier and a second transorber positioned on an input side of the amplifier. The EMP protection unit is configured for instantaneous voltage suppression, i.e., the EMP protection unit can pause input of signals during and EMP event (antenna in OFF state), and once input voltage falls to operational levels, the EMP protection unit will allow input of signals (antenna in ON state). Thus, the EMP protection unit is configured for instantaneous ON/OFF of the antenna. The EMP protection unit is configured for repeated use, i.e., can undergo multiple ON/OFF cycles without degrading.

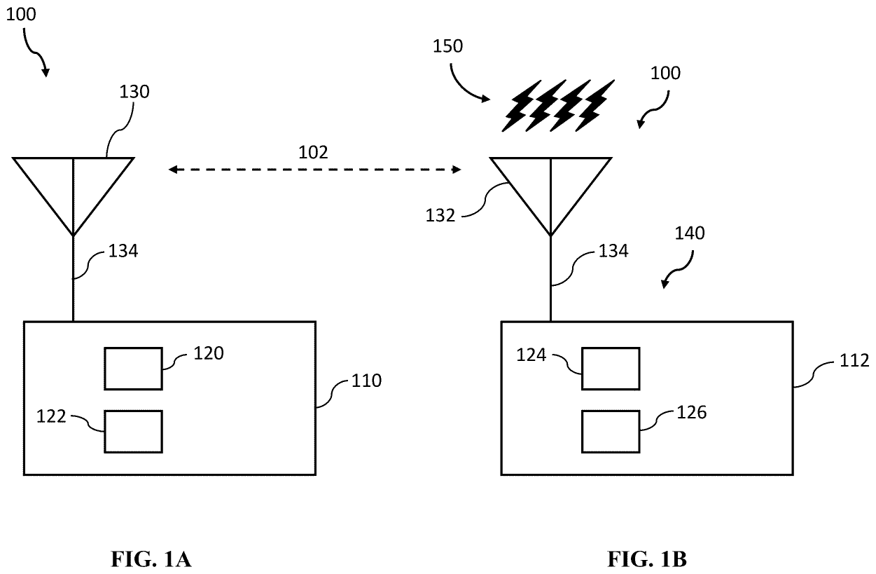

FIG. 1A is a diagrammatic view of an unprotected antenna system 100, according to some embodiments. The unprotected antenna system 100 includes a box 110 to protect electrical components and/or systems within the box 110 from various electromagnetic events. The box 110 could include a faraday cage, a metal box, or any enclosure used to block electromagnetic fields. The box 110 can include a continuous covering or a mesh, such as a metal mesh. In some embodiments, electrical components 120, 122 are located within the box 110. The electrical components 120, 122 inside the box 110 are protected from electromagnetic fields that can result from lightning, static discharge, or a nuclear event. The box 110 includes an antenna 130 in electrical communication with the electrical components 120, 122 via a conductor 134. The antenna 130 is for sending and receiving communications from other boxes and/or from a main server.

FIG. 1B is a diagrammatic view of an unprotected antenna system 100 on a main server 140, according to some embodiments. The main server 140 includes an antenna 132 electrically coupled to electrical components 124, 126 to communicate with the box 110 via electromagnetic communications 102. The main server 140 may be enclosed in a box 112 designed to protect the electrical components 124, 126 within the box 112. The electrical components 120, 122, 124, 126 can be designed to withstand a certain level of static discharge or other relatively low level of shock event. In each case the antenna 130, 132 is unprotected and provides an opening or entry point for electromagnetic pulses. In the event of a high-altitude electromagnetic pulse (HEMP) the amount of electromagnetic energy received at the antenna 130, 132 would be transmitted into the respective box 110, 112 and to the electrical components 120, 122, 124, 126 within the box. Even though the components inside the box may be protected to some degree from electrostatic discharge, the energy from a HEMP 150 would damage the circuitry and/or the electrical components 120, 122, 124, 126, i.e., the voltage and current received by the antenna 130, 132 and input into the circuitry and/or the electrical components 120, 122, 124, 126 would cause the circuitry/components extreme thermal stress, electrical overstress, and component failure. Permanent damage to the circuitry and/or the electrical components 120, 122, 124, 126 would leave the infrastructure without controls. For example, if the system shown in FIG. 1A-B was used to control light signals and track switches on a railroad, airport communication, water treatment plants, power plants, manufacturing sites, etc., disruptions to communication systems could have severe repercussions.

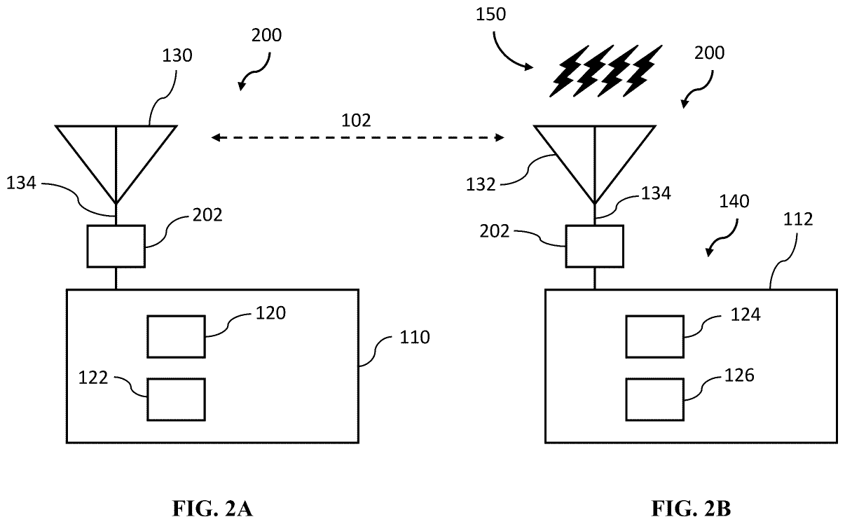

FIG. 2A is a diagrammatic view of an antenna system 200 including an EMP protection unit 202, according to some embodiments. The antenna system 200 includes the antenna 130 and the conductor 134 electrically coupled to the electrical components 120, 122. The EMP protection unit 202 is disposed between the antenna 130 and the electrical components 120, 122 to suppress transient voltages received on the antenna 130 before the transient voltages reaches the electrical components 120, 122.

FIG. 2B is a diagrammatic view of the antenna system 200 on the main server 140, according to some embodiments. The main server 140 includes the antenna 132 electrically coupled to electrical components 124, 126 to communicate with the box 110 via electromagnetic communications 102. The EMP protection unit 202 is disposed between the antenna 132 and the electrical components 124, 126 to suppress transient voltages (e.g., from the HEMP 150) received on the antenna 132 before the transient voltages reaches the electrical components 124, 126.

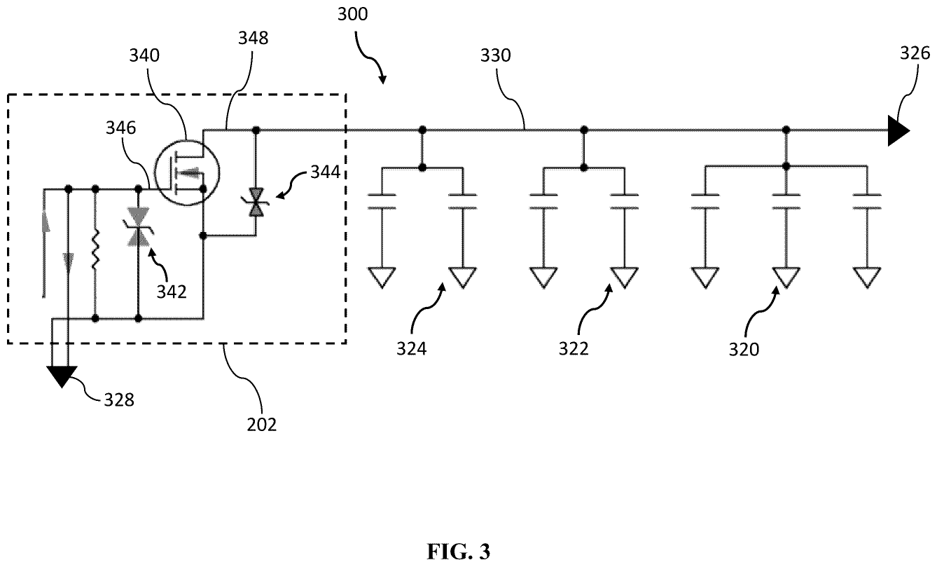

FIG. 3 is a schematic diagram of an antenna system 300 including the EMP protection unit 202, according to some embodiments. The antenna system 300 includes antenna elements 320, 322, 324 for receiving electromagnetic signals (e.g., radio waves) transmitted through the atmosphere. The electromagnetic signals induce a current in a conductor 330 electrically coupled to the antenna elements 320, 322, 324. The electromagnetic signals are typically low power, and the amount of current/voltage induced are low power. The electromagnetic signal received is amplified or boosted by an amplifier 340 to a level where it can be input to a receiver 328.

In some embodiments, the amplifier 340 is a field effect transistor (FET). The amplifier 340 may be configured for bi-directional amplification, i.e., can amplify signals received from the antenna elements 320, 322, 324 and amplify output signals to an output antenna 326. The EMP protection unit 202 includes a first transober 342 and a second transober 344. The amplifier 340 is positioned between the first transober 342 and the second transober 344, according to some embodiments. The first transober 342 is coupled from gate to source of the amplifier 340, and the second transober 344 is coupled from source to drain of the amplifier 340, according to some embodiments. The first transober 342 and the second transober 344 are bi-directional transober, according to some embodiments.

In some embodiments, the first and second transobers 342, 344 are configured to operate dependent upon the expected antenna gain. Received signals greater than 1.15 the expected antenna gain (15% greater than the expected antenna gain) activates the EMP protection unit 202. The first transober 342 and/or the second transober 344 suppresses the gain exceeding 1.15 times the expected antenna gain. The 1.15 times the expected antenna gain is allowed to pass to the receiver 328. Once the gain returns to the expected antenna gain or at least to 1.15 times the antenna expected gain, the entire received signal is input into the amplifier 340 to allow normal operation.

In some embodiments, the EMP protection unit 202 is configured for instantaneous voltage suppression, i.e., the EMP protection unit 202 can pause input of signals during and EMP event (antenna in OFF state), and once input voltage falls to operational levels, the EMP protection unit 202 will allow input of signals (antenna in ON state). Thus, the EMP protection unit 202 is configured for instantaneous ON/OFF of the antenna. The EMP protection unit 202 is configured for repeated use, i.e., can undergo multiple ON/OFF cycles without degrading.

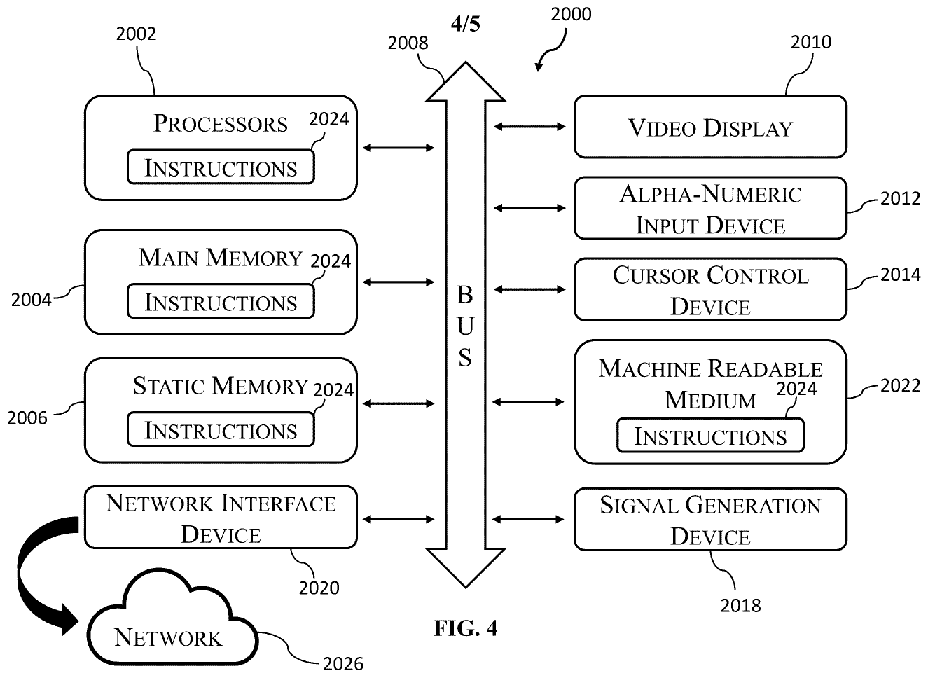

FIG. 4 is a diagrammatic view of a computing system 2000 for a machine, according to some embodiments. The computing system 2000 includes a set of instructions for causing the machine to perform any one or more of the methodologies discussed herein can be executed or is adapted to include the apparatus for generating radiation reports as described herein. In some embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as a Moving Picture Experts Group Audio Layer 3 (MP3) player, a web appliance, a network router, a switch, a bridge, or any machine capable of executing a set of instructions (sequential or otherwise) that specify actions to be taken by that machine. While only a single machine is illustrated, the term “machine” shall also be taken to include any collection of machines that individually or jointly execute a set (or multiple sets) of instructions to perform any one or more of the methodologies discussed herein.

The computing system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a signal generation device 2018 (e.g., a speaker), a network interface device 2020, and a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media. The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

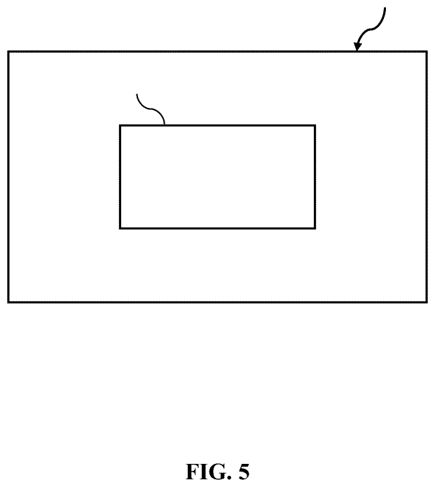

FIG. 5 is a diagrammatic view of a machine readable medium 1300 including an instruction set 1310, according to some embodiments. The machine-readable medium 1300 that provides instructions 1310 that, when executed by a machine, cause the machine to perform operations including eliciting and receiving an input to identify a selected investment, and eliciting and receiving an initial offering price for the investment. The machine readable medium 1300 also includes instructions that, when executed by a machine, cause the machine to perform operations that include receiving an input related to prompt displayed on a recycling container, identifying a marketing opportunity associated with the prompt, identifying the source of the received input, and sending the marketing opportunity to the source.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

In some aspects, the techniques described herein relate to an antenna system, including: an antenna configured to receive electromagnetic signals; one or more electrical components in electrical communication with the antenna; and an electromagnetic pulse (EMP) protection unit electrically coupled with the antenna and the one or more electrical components, the EMP protection unit including an amplifier, a first transober, and a second transober, wherein the amplifier is disposed between the first transober and the second transober.

In some aspects, the techniques described herein relate to an antenna system, wherein the amplifier is a field effect transistor (FET), wherein the first transober is coupled from gate to source of the FET, and the second transober is coupled from source to drain of the FET.

In some aspects, the techniques described herein relate to an antenna system, wherein the first transober and the second transober are bi-directional transobers.

In some aspects, the techniques described herein relate to an antenna system, wherein the EMP protection unit is configured to suppresses gain exceeding 1.15 times an expected antenna gain via the first transober and the second transober suppressing excess gain.

In some aspects, the techniques described herein relate to an antenna system, wherein the EMP protection unit is configured for multiple cycles of transient voltage suppression.

In some aspects, the techniques described herein relate to an antenna system, wherein the gain suppression is achieved without interruption of a received signal transmission.

In some aspects, the techniques described herein relate to an antenna system, wherein the one or more electrical components are disposed within a box configured to block electromagnetic fields.

In some aspects, the techniques described herein relate to an antenna system, wherein the box is a faraday cage including an opening to receive a conductor therethrough.

In some aspects, the techniques described herein relate to an antenna system, wherein the conductor electrically couples the antenna to the one or more electrical components.

In some aspects, the techniques described herein relate to an antenna system, wherein the EMP protection unit is configured to suppress transient voltage received on the antenna from a high-altitude electromagnetic pulse (HEMP) to protect the one or more electrical components.

In some aspects, the techniques described herein relate to an electronic device including: a microprocessor; memory coupled to the microprocessor; a communications port including an antenna, the communications port in electrical communication with the microprocessor for sending and receiving signal; an amplifier for amplifying signals received by the antenna; a first transorber; and a second transorber, the first transorber and the second transorber referenced to one another, one of the first transorber and the second transorber monitoring an amount of gain such that when a gain signal goes beyond a threshold value, the other of the first transorber and the second transorber, shorts the incoming signal to ground until the amount of gain is equal to or less than the threshold value.

In some aspects, the techniques described herein relate to an electronic device, wherein the threshold value is 1.15 times an expected antenna gain.

In some aspects, the techniques described herein relate to an electronic device, wherein the amplifier is a field effect transistor (FET), wherein the first transober is coupled from gate to source of the FET, and the second transober is coupled from source to drain of the FET.

In some aspects, the techniques described herein relate to an electronic device, wherein the first transober and the second transober are bi-directional transobers.

In some aspects, the techniques described herein relate to an electronic device, wherein the first transober and the second transober are configured for multiple cycles of transient voltage suppression.

In some aspects, the techniques described herein relate to an electronic device, wherein the gain suppression is achieved without interruption of a received signal transmission.

In some aspects, the techniques described herein relate to an electronic device, wherein the microprocessor is disposed within a box configured to block electromagnetic fields.

In some aspects, the techniques described herein relate to an electronic device, wherein the box is a faraday cage including an opening to receive a conductor therethrough.

In some aspects, the techniques described herein relate to an electronic device, wherein the conductor electrically couples the antenna to the one or more electrical components.

In some aspects, the techniques described herein relate to an electronic device, wherein the EMP protection unit is configured to suppress transient voltage received on the antenna from a high-altitude electromagnetic pulse (HEMP) to protect the one or more electrical components.

1. An antenna system, comprising:
an antenna configured to receive electromagnetic signals;
one or more electrical components in electrical communication with the antenna; and
an electromagnetic pulse (EMP) protection unit electrically coupled with the antenna and the one or more electrical components, the EMP protection unit including an amplifier, a first transober, and a second transober,
wherein the amplifier is disposed between the first transober and the second transober.

2. The antenna system of claim 1, wherein the amplifier is a field effect transistor (FET), wherein the first transober is coupled from gate to source of the FET, and the second transober is coupled from source to drain of the FET.

3. The antenna system of claim 2, wherein the first transober and the second transober are bi-directional transobers.

4. The antenna system of claim 3, wherein the EMP protection unit is configured to suppresses gain exceeding 1.15 times an expected antenna gain via the first transober and the second transober suppressing excess gain.

5. The antenna system of claim 4, wherein the EMP protection unit is configured for multiple cycles of transient voltage suppression.

6. The antenna system of claim 5, wherein the gain suppression is achieved without interruption of a received signal transmission.

7. The antenna system of claim 1, wherein the one or more electrical components are disposed within a box configured to block electromagnetic fields.

8. The antenna system of claim 7, wherein the box is a faraday cage including an opening to receive a conductor therethrough.

9. The antenna system of claim 8, wherein the conductor electrically couples the antenna to the one or more electrical components.

10. The antenna system of claim 9, wherein the EMP protection unit is configured to suppress transient voltage received on the antenna from a high-altitude electromagnetic pulse (HEMP) to protect the one or more electrical components.

11. An electronic device comprising:
a microprocessor;
memory coupled to the microprocessor;
a communications port including an antenna, the communications port in electrical communication with the microprocessor for sending and receiving signal;
an amplifier for amplifying signals received by the antenna;
a first transorber; and
a second transorber, the first transorber and the second transorber referenced to one another, one of the first transorber and the second transorber monitoring an amount of gain such that when a gain signal goes beyond a threshold value, the other of the first transorber and the second transorber, shorts the incoming signal to ground until the amount of gain is equal to or less than the threshold value.

12. The electronic device of claim 11, wherein the threshold value is 1.15 times an expected antenna gain.

13. The electronic device of claim 11, wherein the amplifier is a field effect transistor (FET), wherein the first transober is coupled from gate to source of the FET, and the second transober is coupled from source to drain of the FET.

14. The electronic device of claim 13, wherein the first transober and the second transober are bi-directional transobers.

15. The electronic device of claim 14, wherein the first transober and the second transober are configured for multiple cycles of transient voltage suppression.

16. The electronic device of claim 15, wherein the gain suppression is achieved without interruption of a received signal transmission.

17. The electronic device of claim 11, wherein the microprocessor is disposed within a box configured to block electromagnetic fields.

18. The electronic device of claim 17, wherein the box is a faraday cage including an opening to receive a conductor therethrough.

19. The electronic device of claim 18, wherein the conductor electrically couples the antenna to the one or more electrical components.

20. The electronic device of claim 19, wherein the EMP protection unit is configured to suppress transient voltage received on the antenna from a high-altitude electromagnetic pulse (HEMP) to protect the one or more electrical components.
